(19) United States
(12) Patent Application Publication
(10) Pub. No.: US 2011/0310714 A1
(43) Pub. Date: Dec. 22, 2011

(54) SENSORLESS MOTOR DRIVE DEVICE

(76) Inventors: Taishi IWANAGA, Shiga (JP); Fumihisa WATANABE, Shiga (JP); Masayoshi IGARASHI, Osaka (JP); Makito NAKATSUKA, Osaka (JP)

(21) Appl. No.: 13/074,933

(22) Filed: Mar. 29, 2011

(30) Foreign Application Priority Data
Jun. 21, 2010 (JP) 2010-140824

(51) Int. Cl. G11B 19/20; H02P 6/20; G11B 7/085; H02P 6/18

(52) U.S. Cl. 369/30.1; 318/400.09; 318/400.1; 369/53.28; G9B/7.042; G9B/19.027

(57) ABSTRACT

A sensorless motor drive device has: a first operation mode of generating current waveforms including non-energizing times based on a first rotor position signal generated by detecting zero crossings in windings of a motor as a signal indicating the rotor position of the motor, and supplying currents to the windings of the motor according to the current waveforms; and a second operation mode of generating current waveforms including no non-energizing time based on a second rotor position signal generated without use of zero crossings as the signal indicating the rotor position of the motor, and supplying currents to the windings of the motor according to the current waveforms. The first and second operation modes can be switched to each other.

### CROSS-REFERENCE TO RELATED APPLICATION

This application claims priority to Japanese Patent Application No. 2010-140824 filed on Jun. 21, 2010, the disclosure of which including the specification, the drawings, and the claims is hereby incorporated by reference in its entirety.

### BACKGROUND

The present disclosure relates to a motor drive device, and more particularly to a technique of driving a sensorless motor having no sensor for detection of the rotor position.

In an optical disc apparatus, etc., a motor drive device is used for driving a spindle motor. In recent years, it has been requested to reduce the cost of the motor drive device. To meet this request, sensorless motors having no sensor for detection of the rotor position are often used. A sensorless motor drive device normally energizes the motor while detecting the rotor position by detecting zero crossings of a counter-electromotive voltage generated in motor windings due to rotation of the motor. In such a sensorless motor drive device, for precise detection of zero crossings, non-energizing times are provided periodically in current waveforms for energized phases, and currents are supplied to the windings of the motor according to the corresponding current waveforms (see Japanese Patent Publication No. 2005-39991, for example).

### SUMMARY

In the sensorless motor drive device, the motor sometimes vibrates and generates vibration-caused noise during non-energizing times. In general, in optical disc apparatuses, which are used inside a quiet room in many cases, it is desirable to reduce motor drive noise made by the sensorless motor drive device as much as possible. However, since it is essential for the sensorless motor drive device to have non-energizing times for detection of zero crossings from the standpoint of its principle, it is difficult to reduce the motor drive noise.

It is an objective of the present disclosure to provide a sensorless motor drive device capable of reducing vibration and noise during motor driving.

The sensorless motor drive device has: a first operation mode of generating current waveforms including non-energizing times based on a first rotor position signal generated by detecting zero crossings in windings of the motor as a signal indicating a rotor position of a motor, and supplying currents to the windings of the motor according to the current waveforms; and a second operation mode of generating current waveforms including no non-energizing time based on a second rotor position signal generated without use of zero crossings in the windings of the motor as the signal indicating the rotor position of the motor, and supplying currents to the windings of the motor according to the current waveforms, wherein the first and second operation modes can be switched to each other.

Having the above operation modes, the motor can be driven with current waveforms including no non-energizing time, permitting reduction in vibration and noise during motor driving.

Specifically, the sensorless motor drive device described above includes: a position detection circuit configured to generate the first rotor position signal; a selection circuit configured to select one of the first and second rotor position signals according to a selection signal supplied; and a pulse generation circuit configured to generate a pulse signal for generating non-energizing times based on the first rotor position signal when the selection signal is at least in a state indicating the first operation mode.

The sensorless motor drive device described above may further include a mask circuit configured to mask the pulse signal when the selection signal is in a state indicating the second operation mode.

Alternatively, it is preferred that the pulse generation circuit does not generate the pulse signal when the selection signal is in a state indicating the second operation mode.

### BRIEF DESCRIPTION OF THE DRAWINGS

FIG. 1 is a block diagram of an optical disc apparatus provided with a sensorless motor drive device of the first embodiment.

FIG. 2 is a timing chart of the sensorless motor drive device in FIG. 1.

FIG. 3 is a block diagram of an optical disc apparatus provided with a sensorless motor drive device of the second embodiment.

### DETAILED DESCRIPTION

### First Embodiment

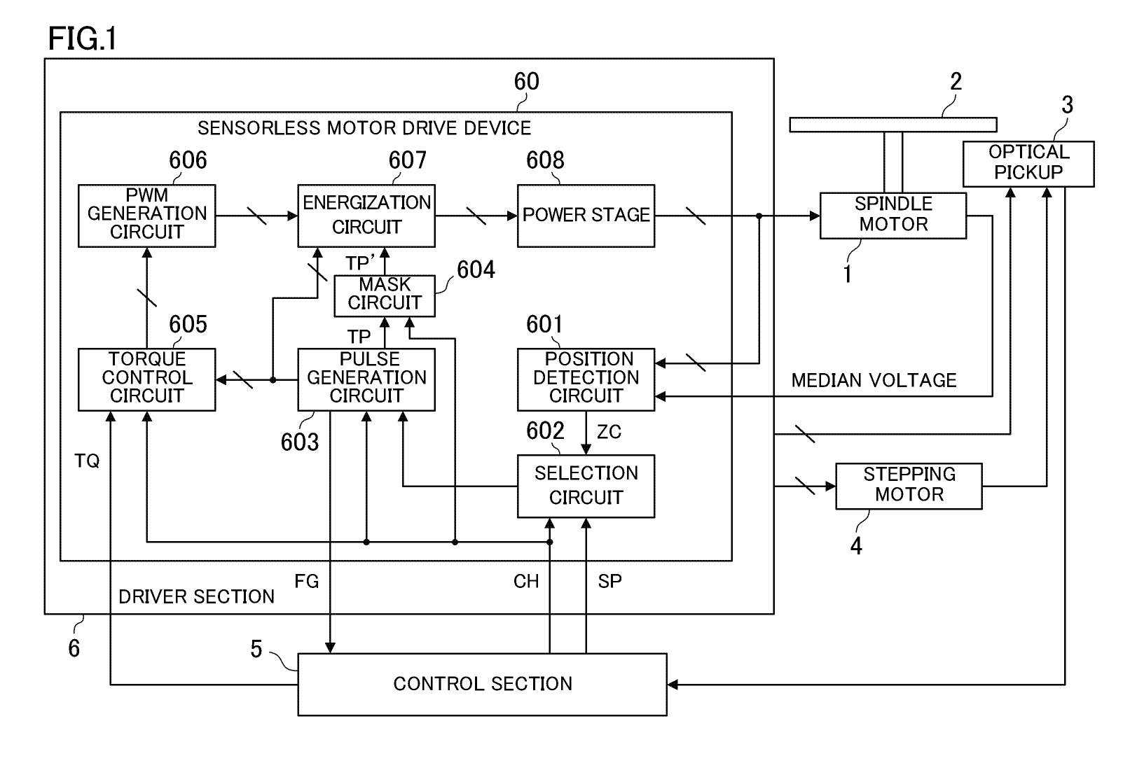

FIG. 1 is a block diagram of an optical disc apparatus provided with a sensorless motor drive device of the first embodiment. A motor 1, which is a spindle motor, may be comprised of a 3-phase sensorless brushless motor, for example. An optical disc 2 is fixed to a rotor of the motor 1 with a chuck, a damper, etc. and rotates with the rotor. Being fixed in this way, the optical disc 2 can rotate at the same phase as the rotation phase of the rotor at all times without deviation. An optical pickup 3, which may be comprised of a lens and various coils, irradiates the optical disc 2 with laser light to perform data read, write, etc. A motor 4, which is a stepping motor, moves the optical pickup 3 in the direction of the radius of the optical disc 2.

A control section 5 generates a torque command signal TQ, a rotor position signal SP indicating the position of the rotor of the motor 1, and a selection signal CH for changing the operation mode of a sensorless motor drive device 60. More specifically, the control section 5 generates a focus error (FE) signal including periodic wobbling information for one rotation of the optical disc 2 from the output of the optical pickup 3. Also, the control section 5 detects the period of one rotation of the optical disc 2 from the FE signal based on a FG signal representing the rotational velocity of the motor 1, and divides the period into parts of an electrical angle of 60 degrees each, to obtain SP. The control section 5 then generates a divided signal corresponding to the electrical angle of 60 degrees of the FG signal, and changes CH from low to high when the divided signal and SP have become the same in phase. The control section 5 may change CH to high when the phase difference between the divided signal and SP has become smaller than a threshold value considering this as if these signals have become the same in phase, or may change CH to high when determining that the rotational velocity of the motor 1 has become a predetermined value or more based on the FG signal. Otherwise, the control section 5 may change CH to high when a predetermined number of pulses or more have occurred in the FG signal, or when a predetermined time has passed since startup of the sensorless motor drive device 60. Also, the control section 5 may generate SP based on a tracking error signal.

A driver section 6 drives the motor 1, the optical pickup 3, and the motor 4 based on the outputs of the control section 5. The sensorless motor drive device 60 changes, according to CH, its operation mode between the mode of driving the motor 1 with current waveforms including non-energizing times and the mode of driving the motor 1 with current waveforms including no non-energizing time.

More specifically, a position detection circuit 601 compares a counter-electromotive voltage generated in the windings of the motor 1 with a median voltage, to detect zero crossings of the counter-electromotive voltage, and generates a signal ZC indicating the rotor position of the motor 1 as the zero crossing detection result. Since the detection interval of zero crossings corresponds with the electrical angle of 60 degrees, ZC is a pulse signal of an electrical angle of 60 degrees.

A selection circuit 602 selects ZC when CH is low, and selects SP when CH is high, i.e., when ZC and SP have become the same in phase. A pulse generation circuit 603 measures a segment of an electrical angle of 60 degrees of the signal selected by the selection circuit 602, and divides this segment into sub-segments of an electrical angle of 3.75 degrees each, for example, to generate an angular signal representing the sub-segments. Based on the angular signal, the pulse generation circuit 603 generates a pulse signal TP for generating non-energizing times during which no energization is made for the motor 1. Also, the pulse generation circuit 603 generates the FG signal based on ZC when CH is low. The FG signal is a signal output once for every six times of output of ZC. A mask circuit 604 outputs TP as it is as a pulse signal TP′ when CH is low, and masks TP when CH is high.

The mask circuit 604 may be omitted. In this case, the pulse generation circuit 603 may just generate TP′ when CH is low and stop generation of TP′ when CH is high. A torque control circuit 605 generates a torque control signal as a current waveform to be applied to the motor 1 based on the angular signal and TQ. More specifically, the torque control circuit 605 generates a torque control signal of a roughly trapezoidal wave when CH is low, and generates a torque control signal of a roughly sine wave when CH is high, for example. Alternatively, the torque control circuit 605 may generate a torque control signal including non-energizing times when CH is low, and generate a torque control signal including no non-energizing time when CH is high, based on the angular signal, TQ, and TP′.

A pulse width modulation (PWM) generation circuit 606 generates PWM pulses corresponding to the torque control signal generated by the torque control circuit 605. An energization circuit 607 generates a control signal for controlling energization of the motor 1 based on the PWM pulses, the angular signal, and TP′. Also, the energization circuit 607 performs switching of the energized phases of the motor 1 based on the angular signal and TP′. A power stage 608 supplies currents to the windings of the motor 1 under the control of the energization circuit 607.

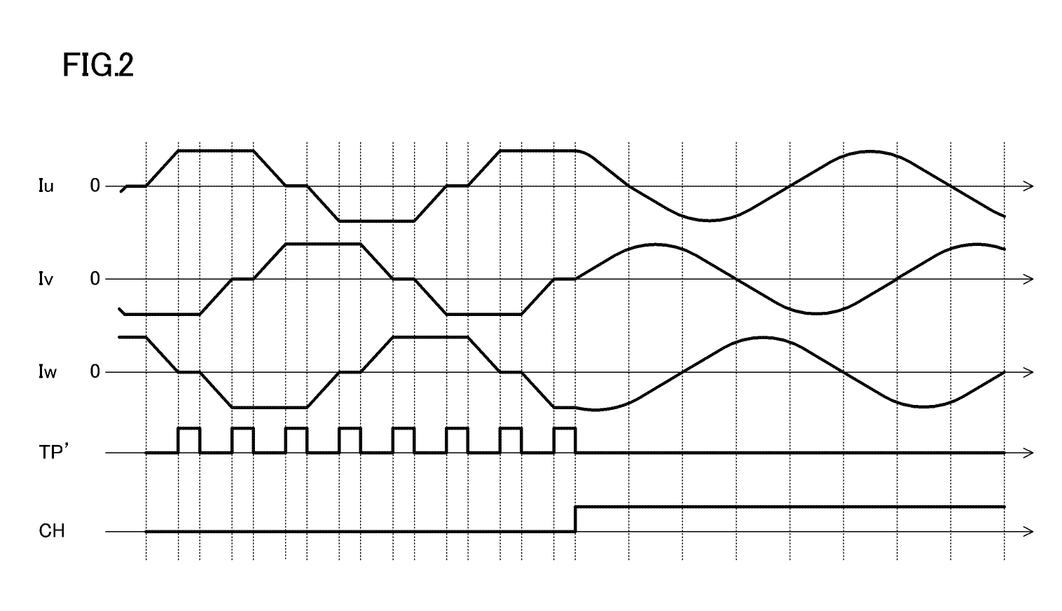

Next, the operation of the sensorless motor drive device 60 of this embodiment will be described with reference to FIG. 2. Iu, Iv, and Iw denote current waveforms flowing to the energized phases of the motor 1. When CH is low, the current waveforms to be applied to the motor 1 are a roughly trapezoidal wave, in which non-energizing times are set according to TP′. When CH goes high, TP′ is fixed to the low level and the current waveforms become a roughly sine wave. In this way, the currents Iu, Iv, Iw as shown in FIG. 2 flow to the energized phases of the motor 1.

As described above, in this embodiment, in which the sensorless motor can be driven with current waveforms including no non-energizing time, vibration and noise during motor driving can be reduced. In particular, when the optical disc 2 is controlled at a constant angular velocity (CAV) where the rotational velocity is constant, the actual rotor position matches with the rotor position indicated by SP at any time. Therefore, the motor can be driven with the current waveforms including no non-energizing time for a long time. In other words, the motor can be driven with lower noise.

Although the optical disc apparatus was described in this embodiment, the present disclosure is also applicable to magneto-optical (MO) disc apparatuses, and even to any electronic apparatus provided with the sensorless motor drive device 60. The relationships between the operations of the selection circuit 602, the pulse generation circuit 603, the mask circuit 604, and the torque control circuit 605 and the logical levels of CH, TP, and TP′ are not limited to that described above. For example, the selection circuit 602 may select SP when CH is low and select ZC when CH is high.

It is desirable that the control section 5 changes CH back to low after a lapse of a predetermined time since CH has become high. For example, in the optical disc apparatus, when the optical disc 2 is controlled at a constant linear velocity (CLV) where the linear velocity is constant, or controlled in a manner requiring sharp acceleration/deceleration of the optical disc 2, a deviation may occur between the rotor position indicated by SP and the actual rotor position. In such a case, by changing CH to low to renew generation of ZC and the FG signal, thereby to correct the phase of SP to match with the phase of ZC, the rotation of the motor 1 can be stabilized.

The control section 5 may generate SP based on the position of the optical pickup 3 in the direction of the radius of the optical disc 2 and the linear velocity of the optical disc 2 at this position. For example, the position of the optical pickup 3 is calculated based on the number of revolutions of the motor 4 and physical address information such as land pre-pits pre-formatted in DVD-R. The linear velocity of the optical disc 2 at the position of the optical pickup 3 is calculated by measuring a RF signal and a wobble signal from the optical pickup 3 using the frequency of a clock generated by a phase locked loop (PLL) circuit. By calculating the circumference of the optical disc 2 at the position and dividing the circumference by the linear velocity, the period of one rotation of the optical disc 2 is calculated. SP can be generated from this period.

### Second Embodiment

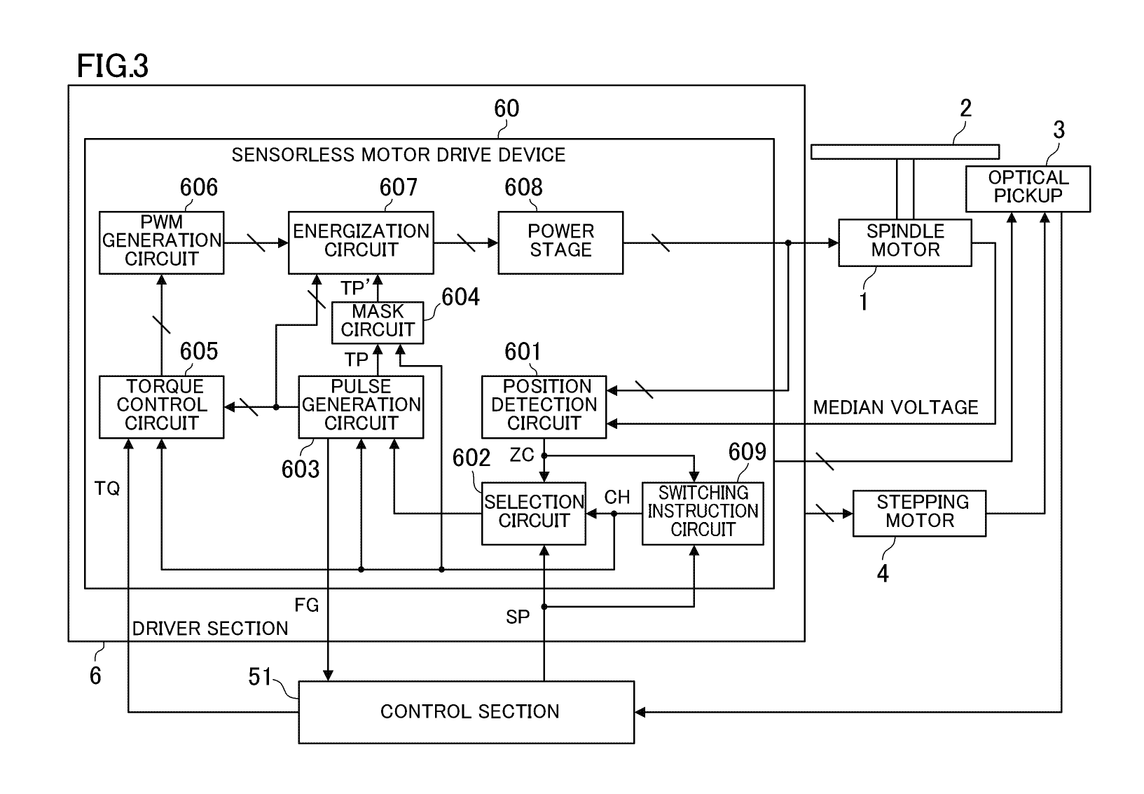

FIG. 3 is a block diagram of an optical disc apparatus provided with a sensorless motor drive device of the second embodiment. A control section 51 generates SP and TQ. A switching instruction circuit 609 generates CH. Also, the switching instruction circuit 609 compares the phase of ZC with the phase of SP, and changes CH from low to high when the phases of ZC and SP have become the same. The switching instruction circuit 609 may change CH to high when the phase difference between ZC and SP has become smaller than a threshold value considering this as if the phases of these signals have become the same. Otherwise, the switching instruction circuit 609 may change CH to high when determining that the rotational velocity of the motor 1 has become a predetermined value or more based on the FG signal, when a predetermined number of pulses or more have occurred in the FG signal, and when a predetermined time has passed since startup of the sensorless motor drive device 60.

With the configuration in this embodiment, also, the sensorless motor can be driven with current waveforms including no non-energizing time, permitting reduction in vibration and noise during motor driving.

What is claimed is:

1. A sensorless motor drive device, having:
a first operation mode of generating current waveforms including non-energizing times based on a first rotor position signal generated by detecting zero crossings in windings of the motor as a signal indicating a rotor position of a motor, and supplying currents to the windings of the motor according to the current waveforms; and
a second operation mode of generating current waveforms including no non-energizing time based on a second rotor position signal generated without use of zero crossings in the windings of the motor as the signal indicating the rotor position of the motor, and supplying currents to the windings of the motor according to the current waveforms, wherein
the first and second operation modes can be switched to each other.

2. The device of claim 1, comprising:
a position detection circuit configured to generate the first rotor position signal;
a selection circuit configured to select one of the first and second rotor position signals according to a selection signal supplied; and
a pulse generation circuit configured to generate a pulse signal for generating non-energizing times based on the first rotor position signal when the selection signal is at least in a state indicating the first operation mode.

3. The device of claim 2, further comprising:
a mask circuit configured to mask the pulse signal when the selection signal is in a state indicating the second operation mode.

4. The device of claim 2, wherein
the pulse generation circuit does not generate the pulse signal when the selection signal is in a state indicating the second operation mode.

5. The device of claim 2, further comprising:
a switching instruction circuit configured to generate the selection signal, wherein
the switching instruction circuit compares phases of the first and second rotor position signals with each other and, when the phases have become the same, changes the selection signal to a state indicating the second operation mode.

6. The device of claim 2, further comprising:
a switching instruction circuit configured to generate the selection signal, wherein
the switching instruction circuit compares phases of the first and second rotor position signals with each other and, when a phase difference between the first and second rotor position signals has become smaller than a threshold value, changes the selection signal to a state indicating the second operation mode.

7. The device of claim 2, further comprising:
a switching instruction circuit configured to generate the selection signal, wherein
when the selection signal is in the state indicating the first operation mode, the pulse generation circuit generates a velocity signal representing the rotational velocity of the motor based on the first rotor position signal, and
when determining that the rotational velocity of the motor has become a predetermined value or more based on the velocity signal, the switching instruction circuit changes the selection signal to a state indicating the second operation mode.

8. The device of claim 2, further comprising:
a switching instruction circuit configured to generate the selection signal, wherein
when the selection signal is in the state indicating the first operation mode, the pulse generation circuit generates a velocity signal representing the rotational velocity of the motor based on the first rotor position signal, and
when a predetermined number of pulses or more have occurred in the velocity signal, the switching instruction circuit changes the selection signal to a state indicating the second operation mode.

9. The device of claim 2, further comprising:
a switching instruction circuit configured to generate the selection signal, wherein
the switching instruction circuit changes the selection signal to a state indicating the second operation mode after a lapse of a predetermined time since startup of the device.

10. The device of claim 2, further comprising:
a torque control circuit configured to generate a torque control signal of a roughly trapezoidal wave as a current waveform when the selection signal is in the state indicating the first operation mode, and generate a torque control signal of a roughly sine wave as a current waveform when the selection signal is in a state indicating the second operation mode.

11. A sensorless motor drive device having:
a first operation mode of generating current waveforms including non-energizing times based on a first rotor position signal generated inside the device as a signal indicating a rotor position of a motor, and supplying currents to windings of the motor according to the current waveforms; and
a second operation mode of generating current waveforms including no non-energizing time based on a second rotor position signal generated outside the device as the signal indicating the rotor position of the motor, and supplying currents to the windings of the motor according to the current waveforms,
wherein
the first and second operation modes can be switched to each other.

12. An electronic apparatus comprising:
the sensorless motor drive device of claim 2; and
a control section configured to generate the selection signal and the second rotor position signal.

13. The apparatus of claim 12, wherein
the control section changes the selection signal to a state indicating the second operation mode when the first and second rotor position signals have become the same in phase.

14. The apparatus of claim 12, wherein
the control section changes the selection signal to a state indicating the second operation mode when a phase difference between the first and second rotor position signals has become smaller than a threshold value.

15. The apparatus of claim 12, wherein
when the selection signal is in the state indicating the first operation mode, the pulse generation circuit generates a velocity signal representing the rotational velocity of the motor based on the first rotor position signal, and
when determining that the rotational velocity of the motor has become a predetermined number of revolutions or more based on the velocity signal, the control section changes the selection signal to a state indicating the second operation mode.

16. The apparatus of claim 12, wherein
when the selection signal is in the state indicating the first operation mode, the pulse generation circuit generates a velocity signal representing the rotational velocity of the motor based on the first rotor position signal, and
when a predetermined number of pulses or more have occurred in the velocity signal, the control section changes the selection signal to a state indicating the second operation mode.

17. The apparatus of claim 12, wherein
the control section changes the selection signal to a state indicating the second operation mode after a lapse of a predetermined time since startup of the sensorless motor drive device.

18. The apparatus of claim 12, wherein
the control section changes the selection signal to the state indicating the first operation mode after a lapse of a predetermined time since the selection signal has changed to a state indicating the second operation mode.

19. The apparatus of claim 12, wherein
the electronic apparatus is an optical disc apparatus, and
the control section generates the second rotor position signal based on a focus error signal of the optical disc apparatus.

20. The apparatus of claim 12, wherein
the electronic apparatus is an optical disc apparatus, and
the control section calculates the position of an optical pickup in a direction of the radius of an optical disc based on physical address information of the optical disc read from the optical disc, and generates the second rotor position signal based on a linear velocity of the optical disc at the calculated position.
